(19) United States
(12) Patent Application Publication
(10) Pub. No.: US 2007/0081670 A1
(43) Pub. Date: Apr. 12, 2007

(54) Data transfer device

(76) Inventors: Andrew Topham, Stoke Gifford (GB); John William Drew, Stoke Gifford (GB); Jonathan Peter Buckingham, Stoke Gifford (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/494,779

(22) Filed: Jul. 26, 2006

(30) Foreign Application Priority Data
Oct. 11, 2005 (GB) 0520601.6

(51) Int. Cl. H04N 7/167

(52) U.S. Cl. 380/239

(57) ABSTRACT

A data transfer device for transferring data to and/or from a removable data storage item, wherein data are encrypted or decrypted during data transfer using a feature of the removable data storage item.

### FIELD OF THE INVENTION

The present invention relates to a data transfer device for transferring data to and/or from a removable data storage item, wherein data are encrypted or decrypted during data transfer using a feature of the removable data storage item.

### BACKGROUND OF THE INVENTION

Data backup is a valuable tool in safeguarding important data. Data are generally backed-up onto removable data storage items, such as tape cartridges or optical discs, such that the backup data may be stored at a different geographical location to the primary data.

By storing important data onto removable data storage items, security issues become a consideration. For example, a visitor to a site might easily pocket a tape cartridge storing large amounts of commercially sensitive data.

Many backup software packages provide the option of encrypting data prior to backup. A drawback with this approach, however, is that the same software package must be used in order to retrieve and decrypt the backup data. Accordingly, backup data cannot be recovered using other legitimate systems where the backup software is not provided.

### SUMMARY OF THE INVENTION

In a first aspect, the present invention provides a data transfer device for storing data to a removable data storage item, the data transfer device being operable to: receive data to be stored; generate an initialisation vector based upon a feature of the removable data storage item; encrypt the data using an encryption key and the initialisation vector; and store the encrypted data to the removable data storage item.

Preferably, the feature is unique to the removable data storage item such that the data transfer device is operable to employ different initialisation vectors for different removable data storage items.

Advantageously, the feature is information unique to the removable data storage item and the data transfer device is operable to obtain the information from the removable data storage item.

Conveniently, the information unique to the removable data storage item comprises a serial number.

Preferably, the removable data storage item is a tape cartridge having a memory device storing the information, and the data transfer device is a tape drive having a reader for reading the contents of the memory device to obtain the information.

Advantageously, the data transfer device is a tape drive and the removable data storage item is a tape cartridge.

In a second aspect, the present invention provides a data transfer device for retrieving and outputting data from a removable data storage item, the data transfer device being operable to: retrieve data from the removable data storage item; generate an initialisation vector based upon a feature that is unique to the removable data storage item; decrypt the data using an encryption key and the initialisation vector; and output the decrypted data.

Preferably, the feature is information unique to the removable data storage item and the data transfer device is operable to obtain the information from the data storage item.

Advantageously, the information unique to the removable data storage item comprises a serial number.

Conveniently, the data transfer device is a tape drive and the removable data storage item is a tape cartridge.

Preferably, the removable data storage item is a tape cartridge having a memory device storing the information, and the data transfer device is a tape drive having a reader for reading the contents of the memory device to obtain the information.

In a third aspect, the present invention provides a data transfer device for storing data to a removable data storage item, the data transfer device comprising: means for receiving data to be stored; means for generating an initialisation vector based upon a feature of the removable data storage item; means for encrypting the data using an encryption key and the initialisation vector; and means for storing the encrypted data to the removable data storage item.

Preferably, the data transfer is suitable for retrieving and outputting data from the removable data storage item, and the data transfer device comprises: means for retrieving data from the removable data storage item; means for decrypting the data using an encryption key and the initialisation vector; and means for outputting the decrypted data.

In a fourth aspect, the present invention provides a method of storing data to a removable data storage item, the method comprising: receiving data to be stored; generating an initialisation vector based upon a feature of the removable data storage item; encrypting the data using an encryption key and the initialisation vector; and storing the encrypted data to the removable data storage item.

Preferably, the method is suitable for retrieving and outputting data from the removable data storage item and comprises: retrieving data from the removable data storage item; decrypting the data using an encryption key and the initialisation vector; and outputting the decrypted data.

Advantageously, the feature is information unique to the removable data storage item and the method further comprises obtaining the information from the removable data storage item.

Conveniently, the information unique to the removable data storage item comprises a serial number.

In a fifth aspect, the present invention provides a computer program product storing computer program code executable by a data transfer device, the computer program product when executed causing the data transfer device to operate as described in the aforementioned aspects of the invention, or to perform the aforementioned methods.

### BRIEF DESCRIPTION OF THE DRAWINGS

In order that the present invention may be more readily understood, embodiments thereof will now be described, by way of example, with reference to the accompanying drawings, in which:

FIG. 1 is a schematic block diagram of a tape drive embodying the present invention;

FIG. 2 is a flow diagram illustrating a method performed by the tape drive of FIG. 1 when reading data from a tape cartridge;

FIG. 3 is a flow diagram illustrating a method performed by the tape drive of FIG. 1 when writing data to a tape cartridge; and

FIG. 4 illustrates AES-CTR encryption; and

FIG. 5 illustrates AES-CTR decryption.

### DETAILED DESCRIPTION

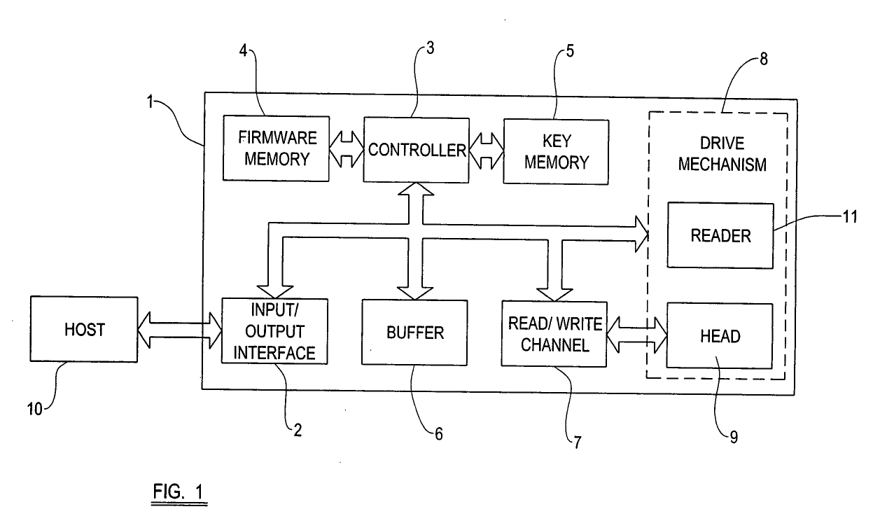

The tape drive 1 of FIG. 1 comprises an input/output interface 2, a controller 3, a first non-volatile memory 4, a second non-volatile memory 5, a memory buffer 6, a read/write channel 7, and a drive mechanism 8 including a magnetic read/write head 9.

The input/output interface 2 controls the exchange of data between the tape drive 1 and a host device 10, such as a host computer. Control signals received from the host device 10 by the interface 2 are delivered to the controller 3, which, in response, controls the operation of the tape drive 1, e.g. the read/write channel 7 and the drive mechanism 8.

The controller 3 comprises a microprocessor, which executes instructions stored in the first non-volatile memory 4. The instructions stored in the first non-volatile memory 4 are generally referred to as firmware and in order to better distinguish the first non-volatile memory 4 from the second non-volatile memory 5, the first non-volatile memory 4 shall hereafter be referred to as firmware memory 4.

The second non-volatile memory 5 stores an encryption key. As described in further detail below, the controller 3 uses the encryption key when writing data to and reading data from a tape cartridge. For the purposes of brevity, as well as to better distinguish the first and second non-volatile memories 4,5, the second non-volatile memory 5 shall hereafter be referred to as key memory 5.

The drive mechanism 8 is responsible for winding the tape of a cartridge about a drum onto which the magnetic read/write head 9 is mounted, and for winding the tape forwards and backwards during use, as required.

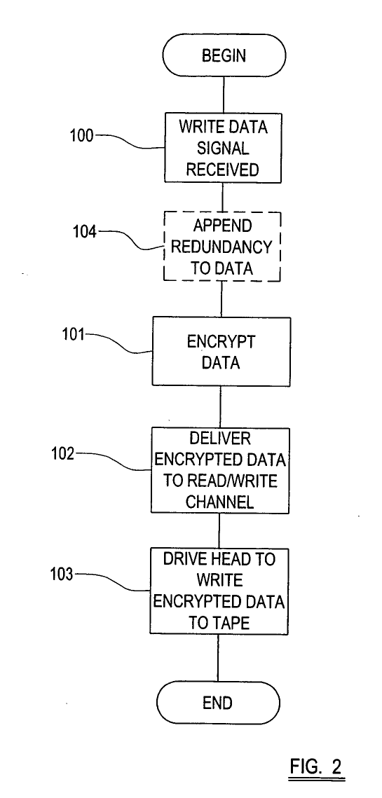

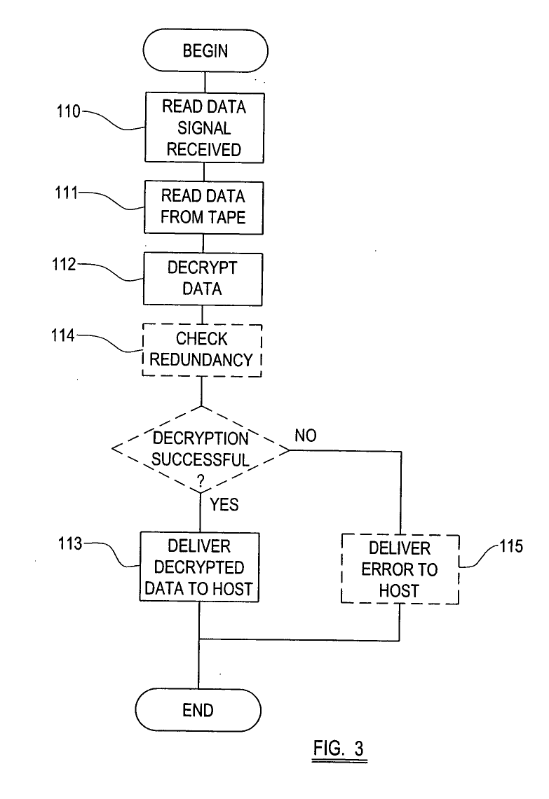

Operation of the tape drive 1, and in particular the controller 3 in executing the firmware instructions stored in firmware memory 4, will now be described with reference to FIGS. 2 and 3.

In response to receiving 100 a write data signal from the host device 10, the controller 3 encrypts 101 the data received from the host device 10 using the encryption key stored in key memory 5. The encrypted data are then delivered 102 to the read/write channel 3, which encodes the encrypted data and converts the encoded, encrypted data into electrical signals suitable for driving 103 the magnetic read/write head 9.

The controller 3 optionally embeds or appends 104 error control coding or redundancy data to the data received from the host device 10 prior to encryption. As detailed below, the inclusion of redundancy data enables the tape drive 1 to determine whether encrypted data later retrieved from a tape have been successfully decrypted.

In response to receiving a read data signal 110 from the host device 10, the controller 3 controls the drive mechanism 8 such that the tape is positioned over the magnetic read/write head 9 at the relevant position at which the requested data are stored. The tape is then wound forwards/backwards and the magnetic read/write head 9 reads 111 the requested data from the tape. The read/write channel 7 converts the resulting analogue signal received from the magnetic read/write head 9 into digital data, which are then decoded by the read/write channel 7 and stored in the memory buffer 6. The controller 3 then decrypts 112 the data using the encryption key stored in key memory 5, stores the decrypted data in the memory buffer 6, and delivers 113 the decrypted data from the memory buffer 6 to the host device 10 via the interface 2.

As noted above, when writing data to tape, the controller 3 optionally embeds or appends 104 redundancy data to the data to be stored prior to encryption. In this embodiment, when reading data from the tape, the controller 3 compares 114 the redundancy data of the decrypted data to that expected had the decryption process been successful. For example, where the redundancy data comprise cyclic redundancy checksum (CRC) data, the controller calculates the CRC data for the decrypted data and compares this against the actual CRC data that are embedded or appended to the decrypted data. If the redundancy data of the decrypted data correspond to that expected, the decrypted data (i.e. without the redundancy data) are delivered 113 to the host device 10 via the interface 2. If, however, the redundancy data of the decrypted data do not correspond to that expected, the controller 3 delivers 115 an error signal to the host device 10 via the interface 2 to indicate that the requested data could not be successfully decrypted. Unsuccessful decryption may arise because the wrong encryption key was used to decrypt the data and/or the data read from the tape were corrupt.

A more detailed discussion of the encryption-decryption process will now be described.

The encryption-decryption algorithm performed by the controller 3 is advanced encryption standard counter mode (AES-CTR).

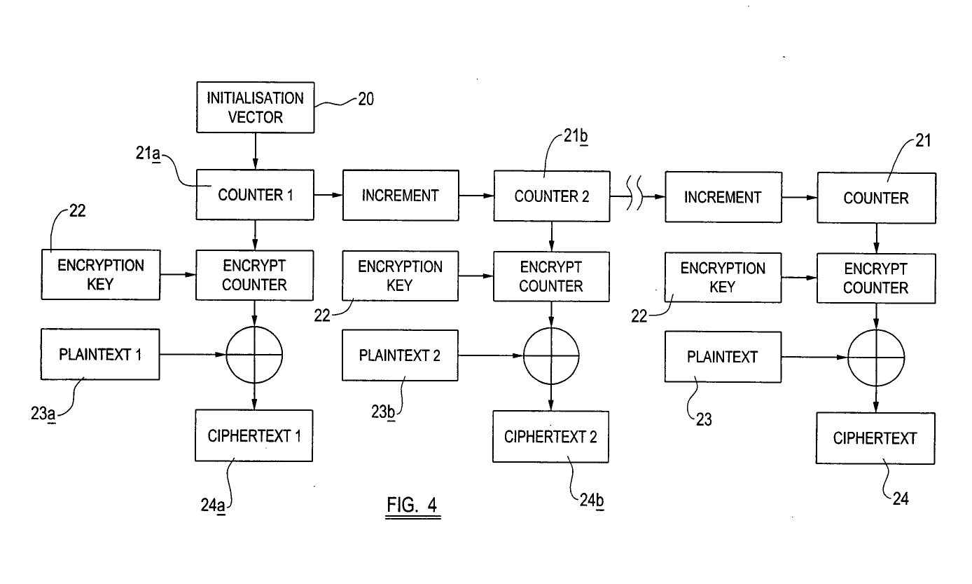

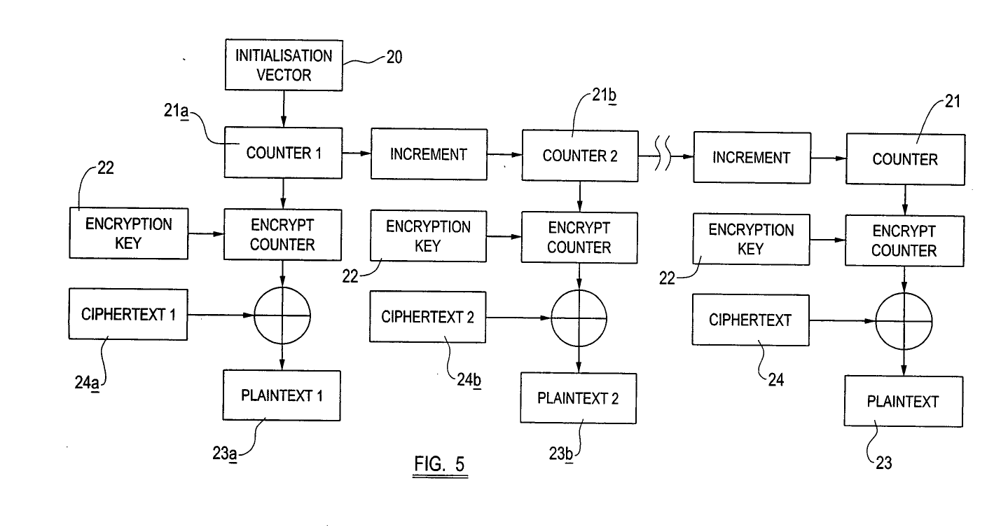

As shown in FIGS. 4 and 5, which illustrate AES-CTR encryption and decryption respectively, an initialisation vector 20 (sometimes referred to as an initial vector) provides a first counter value 21a, which is encrypted by AES encryption using an encryption key 22. The encrypted counter value is then XOR'd with a first block 23a of plaintext 23a to create a first block of ciphertext 24a. The first counter value 21a is then incremented, typically by adding one but other methods can be used, to create a second counter value 21b. The second counter value 21b is then encrypted using the encryption key 22, and the result is XOR'd with a second block of plaintext 23b to create a second block of ciphertext 24b. The process then continues by incrementing the counter 21, encrypting the counter, and XORing the result with a block of plaintext 23 to create a block of ciphertext 24. The process of decryption is identical to that of encryption with the exception that the encrypted counter is XOR'd with a block of ciphertext 24 (rather than plaintext 23) to create a block of plaintext 23 (rather than ciphertext 24). In order for decryption to be successful, the same counter value 21 used to encrypt a block of plaintext 23 must be used to decrypt the corresponding block of ciphertext 24.

AES counter mode provides a high level of security when used correctly. However, it is essential that a different counter value 21 is used when encrypting different blocks of plaintext 23. If the same counter value 21 is used to encrypt different blocks of plaintext 23a,23b, the resulting blocks of ciphertext 24a,24b may be XOR'd together to produce a block that is the XOR of the two plaintext blocks 23a,23b, from which it can prove relatively straightforward to extract the plaintext (i.e. Cipher1 XOR Cipher2=Plain1 XOR Plain2, when the same counter 21 and key 22 are used). It is therefore essential that a different counter 21 and key 22 pair is used when encrypting each block of plaintext 23. This may be achieved in several ways, as will now be described.

In one embodiment, the tape drive 1 is provided with a unique initialisation vector 20 that is stored in key memory 5 along with an encryption key 22. Data received from the host device 10 are then divided by the controller 3 into a series of plaintext blocks 23 and stored in the memory buffer 6. The counter 21 is then set to that of the initialisation vector 20 stored in key memory 5. The controller 3 encrypts the counter 21 using the encryption key 22 stored in key memory 5. The encrypted counter is then XOR'd with the first block of plaintext 23a to create a first block of ciphertext 23b, which is then delivered to the read/write channel 7 for writing to the tape. The controller 3 then increments the counter 21, encrypts the counter 21, the result of which is XOR'd to the next block of plaintext 23 and so on. Importantly, the controller 3 increments the counter 21 for each block of plaintext 23 such that no two blocks of plaintext 23 and encrypted using the same counter 21.

After the controller 3 has finished encrypting data received from the host device 10, the counter 21 is incremented and the result stored as the initialisation vector 20 in key memory 5. The initialisation vector 20 stored in key memory 5 is then used to encrypt further data, regardless of the tape cartridge to which the data are to be stored. Accordingly, every block of plaintext 23 encrypted by the tape drive 1, regardless of the tape cartridge to which the blocks of ciphertext 24 are stored, is encrypted using a different counter 21 and key 22 pair.

In addition to writing encrypted data to the tape, the controller 3 causes the initialisation vector 20 used to encrypt the data to be written to the tape. This initialisation vector is then used during subsequent data retrieval to decrypt the data, as described below. A single initialisation vector may be used with each tape cartridge, in which case no further data may be written to a tape cartridge after it has been ejected. Alternatively, each tape cartridge may store a plurality of initialisation vectors 20, each vector 20 being associated with an item of data that has been encrypted using the vector 20. Each item of data stored on the tape cartridge may comprise one or more blocks of ciphertext 24. For example, a first item of data may be encrypted by the tape drive 1 using a first initialisation vector and then stored onto a tape cartridge. The tape cartridge may then be ejected and the tape drive 1 used with an alternative tape cartridge such that the initialisation vector 20 stored in key memory 5 changes. The original tape cartridge may then be later reinserted into the tape drive 1 and a second item of data encrypted and stored onto the tape cartridge using a second, different initialisation vector. By storing the initialisation vector 20 used to encrypt each item of data, the tape drive 1 is able to later retrieve and successfully decrypt a particular item of data by reading the initialisation vector 20 associated with the item of data.

When retrieving data, the controller 3 arranges (i.e. by controlling the drive mechanism 8, magnetic read/write head 9 and read/write channel 7) for the initialisation vector stored on the tape to be read. Should the tape store more than one initialisation vector, the initialisation vector associated with the data to be retrieved is read. The initialisation vector read from the tape then serves as the first counter value 21a for decrypting the data. The data are then retrieved from the tape and stored in the memory buffer 6. The controller 3 then decrypts the data (i.e. the blocks of ciphertext 24) stored in the memory buffer 6 using the encryption key stored in key memory 5 and the initialisation vector read from the tape.

An advantage of AES-CTR is that a particular block of ciphertext 24 can be decrypted in isolation simply by knowing the appropriate counter value 21 used to encrypt the corresponding block of plaintext 23, i.e. it is not necessary to decrypt all other blocks of ciphertext 24. Accordingly, when the controller 3 receives a read data signal from the host device 10, the controller 3 is able to retrieve and decrypt the relevant data without having to decrypt any other data stored on the tape.

In an alternative embodiment, rather than storing the initialisation vector 20 in key memory 5 within the tape drive 1, the host device 10 may automatically generate and deliver a unique initialisation vector 20 to the tape drive I each time data are to be stored to a tape cartridge. A log is then maintained by the host device 10 of which counter values 21 have been used to ensure that no data are stored on tape cartridges using the same counter 21 and key 22 pair.

For systems comprising more than one tape drive 1, each tape drive 1 employs the same encryption key 22 so that backup data may be retrieved from any one of the tape drives. It is therefore essential that different initialisation vectors 20 are used with each tape cartridge to ensure that all blocks of plaintext 23 encrypted by the various tape drives are encrypted with different counters 21. In the first embodiment described above, each tape drive 1 may be initialised with a different initialisation vector 20 to ensure that no two tape drives encrypt using the same counters 21. In the second embodiment described above, the host device 10 is responsible for generating and delivering initialisation vectors 20 to each of the tape drives of the system. The host device 10 then maintains a log of all counter values 21 that have been used such that on inserting a new tape cartridge into one of the tape drives 1, the host device 10 is able to generate and deliver an initialisation vector 20 that ensures counters 21 are not reused.

In a further alternative embodiment, the initialisation vector 20 used to encrypt data is derived from a feature of the tape cartridge onto which the data are to be stored. As an example, each tape cartridge normally includes a unique serial number that is allocated by the manufacturer of the tape cartridge. This serial number may be used to generate an initialisation vector 20 that is unique to that tape cartridge. The initialisation vector 20 is generated in a manner that ensures that tape cartridges having consecutive serial numbers have initialisation vectors 20 sufficiently different that all blocks of ciphertext 24 stored on tape cartridges are created with different counters 21. For example, the initialization vector 20 for data stored on a tape cartridge may be constructed from the record number of the data, an AES block number (set to zero at the beginning of each record and incremented for each block of ciphertext 24), the tape serial number, and optionally a write pass id (written to the tape or the cartridge memory), which makes each successive over-write unique. The AES block number of the initialization vector 20 is then incremented for each block of ciphertext 24 to create the counter 21. Each initialisation vector 20 and counter 21 comprises 128 bits and may be partitioned as follows:

| Field | Number of Bits | Comments |
|---|---|---|
| Record | 44 | 16 Tera-records |
| AES Block | 20 | Defines the maximum |
| | | number of blocks per |
| | | record |
| Serial Number | 32 | Unique to each tape |
| | | cartridge |
| Write Pass ID | 32 | Ensures each over-write |
| | | is unique |

The unique serial number may be written to the tape header of the tape cartridge, in which case the controller 3 is operable to read the serial number from the tape header in order to construct the initialisation vector 20. The serial number may alternatively, or additionally, be provided as machine-readable information (e.g. a barcode) provided on a label. In a further alternative, certain types of tape cartridge include a memory device (particularly a solid-state memory device) that stores, among other things, a unique serial number. In both these cases, the tape drive 1 may include a reader 11 (FIG. 1), such as an optical reader or transceiver, for reading the machine-readable information or the contents of the memory device, from which the controller 3 then constructs the initialisation vector 20. Finally, the serial number of the tape cartridge may be input by a user using the host device 10. The host device 10 may then deliver the serial number to the tape drive 1 which then uses the serial number to construct an initialisation vector 20, or the host device 10 may itself construct the initialisation vector 20 from the serial number and then deliver the initialisation vector 20 to the tape drive 1.

The use of a unique serial number to generate an initialisation vector 20 has been described by way of example only, and it should be appreciated that any information or feature unique to a tape cartridge may alternatively be used to construct an initialisation vector 20. The tape drive 1 is then operable to read or sense the information or feature unique to the tape cartridge such that the tape drive 1 is able to construct the initialisation vector 20 without the need for any user input or any input from the host device 10.

AES is the encryption standard presently adopted by the US government and is expected to enjoy extensive worldwide use. Accordingly, the encryption algorithm used by the controller 3 is AES and more particularly AES-CTR. AES-CTR uses the same encryption operation to both encrypt and decrypt data (see FIGS. 4 and 5 in which the counter 21 is encrypted regardless of whether AES encryption or decryption is occurring) and therefore the implementation is smaller than that for many other AES modes. Nevertheless, the controller 3 may be operable to perform alternative forms of encryption, including block cipher, stream cipher, symmetric and asymmetric encryption. In particular, the controller 3 may be operable to perform other AES modes (cipher block chaining, cipher feedback, output feedback) or other encryption algorithms in which a private key and public initialisation vector are employed, e.g. 3DES, RC5, Blowfish, IDEA, etc.

In the embodiments described above, the firmware (i.e. the instructions to be executed by the controller 3) and the encryption key 20 (and in some embodiments the initialisation vector 20) are stored in two separate non-volatile memories 4,5. It will, however, be appreciated that both the firmware and the encryption key (and the initialisation vector 20) may be stored in a single, partitioned non-volatile memory.

Although embodiments of the present invention have been described with reference to a tape drive 1, it will be appreciated that the present invention is equally applicable to other types of data transfer devices, such as optical drives.

With the data transfer device embodying the present invention, the encryption and decryption of backup data is moved from the host device to the data transfer device. The data transfer device need not rely upon special commands or control signals in order to encrypt or decrypt data, but may instead encrypt and decrypt data in response to conventional read and write commands received from the host device. Accordingly, the data transfer device is capable of operating using standard hardware interfaces such as SCSI, PCI, IDE, EISA, USB, FireWire®, Bluetooth®, IrDA etc. Moreover, by using a feature unique to each removable data storage item, such as its serial number, to encrypt data stored thereon, data can be securely stored and retrieved using different data transfer devices without compromising the security of the data. In particular, by using a feature of each removable data storage item to create a unique initialisation vector, a single encryption key may be used with different data transfer devices without the danger of the same counter and key pair being reused. This provides a platform whereby encryption keys may be easily and simply managed.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A data transfer device for storing data to a removable data storage item, the data transfer device being operable to:
receive data to be stored;
generate an initialisation vector based upon a feature of the removable data storage item;
encrypt the data using an encryption key and the initialisation vector; and
store the encrypted data to the removable data storage item.

2. A data transfer device according to claim 1, wherein the feature is unique to the removable data storage item such that the data transfer device is operable to employ different initialisation vectors for different removable data storage items.

3. A data transfer device according to claim 1, wherein the feature is information unique to the removable data storage item and the data transfer device is operable to obtain the information from the removable data storage item.

4. A data transfer device according to claim 3, wherein the information unique to the removable data storage item comprises a serial number.

5. A data transfer device according to claim 3, wherein the removable data storage item is a tape cartridge having a memory device storing the information, and the data transfer device is a tape drive having a reader for reading the contents of the memory device to obtain the information.

6. A data transfer device according to claim 1, wherein the data transfer device is a tape drive and the removable data storage item is a tape cartridge.

7. A data transfer device according to claim 1, wherein the data transfer device is suitable for retrieving and outputting data from the removable data storage item and is operable to:
retrieve data from the removable data storage item;
generate an initialisation vector based upon a feature of the removable data storage item;
decrypt the data using the encryption key and the initialisation vector; and
output the decrypted data.

8. A data transfer device for storing data to a removable data storage item, the data transfer device comprising:
means for receiving data to be stored;
means for generating an initialisation vector based upon a feature of the removable data storage item;
means for encrypting the data using an encryption key and the initialisation vector; and
means for storing the encrypted data to the removable data storage item.

9. A data transfer device according to claim 8, wherein the data transfer is suitable for retrieving and outputting data from the removable data storage item, and the data transfer device comprises:
means for retrieving data from the removable data storage item;
means for decrypting the data using an encryption key and the initialisation vector; and
means for outputting the decrypted data.

10. A method of storing data to a removable data storage item, the method comprising:
receiving data to be stored;
generating an initialisation vector based upon a feature of the removable data storage item;
encrypting the data using an encryption key and the initialisation vector; and
storing the encrypted data to the removable data storage item.

11. A method according to claim 10, wherein the feature is unique to the removable data storage item such that different initialisation vectors are generated for different removable data storage items.

12. A method according to claim 11, wherein the information unique to the removable data storage item comprises a serial number.

13. A method according to claim 10, wherein the method further comprises obtaining the information from the removable data storage item.

14. A method according to claim 10, wherein the method is suitable for retrieving and outputting data from the removable data storage item and comprises:
retrieving data from the removable data storage item;
decrypting the data using an encryption key and the initialisation vector; and
outputting the decrypted data.
